(19) United States
(12) Patent Application Publication
(10) Pub. No.: US 2002/0055980 A1
(43) Pub. Date: May 9, 2002

(54) Controlled server loading

(76) Inventor: Steve Goddard, Lincoln, NE (US)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 09/930,014

(22) Filed: Aug. 15, 2001

Related U.S. Application Data
(60) Provisional application No. 60/245,788, filed on Nov. 3, 2000.
(60) Provisional application No. 60/245,789, filed on Nov. 3, 2000.
(60) Provisional application No. 60/245,790, filed on Nov. 3, 2000.
(60) Provisional application No. 60/245,859, filed on Nov. 3, 2000.

(51) Int. Cl. G06F 15/16

(52) U.S. Cl. 709/217; 709/203

(57) ABSTRACT

Standalone and cluster-based servers, including Web servers, control the amount of data processed concurrently by such servers to thereby control server operating performance. A dispatcher is preferably interposed between clients and one or more back-end servers, and preferably monitors the performance of each back-end server (either directly or otherwise). For each back-end server, the dispatcher preferably also controls, in response to the monitored performance, either or both the number of concurrently processed data requests and the number of concurrently supported connections to thereby control the back-end servers' performance. In one embodiment, the dispatcher uses a packet capture library for capturing packets at OSI layer 2 and implements a simplified TCP/IP protocol in user-space (vs. kernel space) to reduce data copying. Commercially off-the-shelf (COTS) hardware and operating system software are preferably employed to take advantage of their price-to-performance ratio.

### CROSS-REFERENCE TO RELATED APPLICATION

This application claims the benefit of U.S. Provisional Application No. 60/245,788 entitled RATE-BASED RESOURCE ALLOCATION (RBA) TECHNOLOGY, U.S. Provisional Application No. 60/245,789 entitled ASSURED QOS REQUEST SCHEDULING, U.S. Provisional Application No. 60/245,790 entitled THE SASHA CLUSTER BASED WEB SERVER, and U.S. Provisional Application No. 60/245,859 entitled ACTIVE SET CONNECTION MANAGEMENT, all filed Nov. 3, 2000. The entire disclosures of the aforementioned applications, and U.S. Application No. 09/878,787 entitled SYSTEM AND METHOD FOR AN APPLICATION-SPACE SERVER CLUSTER, filed Jun. 11, 2001, are incorporated herein by reference.

### FIELD OF THE INVENTION

The present invention relates generally to controlled loading of servers, including standalone and cluster-based Web servers, to thereby increase server performance. More particularly, the invention relates to methods for controlling the amount of data processed concurrently by such servers, as well as to servers and server software embodying such methods.

### BACKGROUND OF THE INVENTION

A variety of Web servers are known in the art for serving the needs of the over 100 million Internet users. Most of these Web servers provide an upper bound on the number of concurrent connections they support. For instance, a particular Web server may support a maximum of 256 concurrent connections. Thus, if such a server is supporting 255 concurrent connections when a new connection request is received, the new request will typically be granted. Furthermore, most servers attempt to process all data requests received over such connections (or as many as possible) simultaneously. In the case of HTTP/1.0 connections, where only one data request is associated with each connection, a server supporting a maximum of 256 concurrent connections may attempt to process as many as 256 data requests simultaneously. In the case of HTTP/1.1 connections, where multiple data requests per connection are permitted, such a server may attempt to process in excess of 256 data requests concurrently.

The same is true for most cluster-based Web servers, where a pool of servers are tied together to act as a single unit, typically in conjunction with a dispatcher that shares or balances the load across the server pool. Each server in the pool (also referred to as a back-end server) typically supports some maximum number of concurrent connections, which may be the same as or different than the maximum number of connections supported by other servers in the pool. Thus, each back-end server may continue to establish additional connections (with the dispatcher or with clients directly, depending on the implementation) upon request until its maximum number of connections is reached.

The operating performance of a server at any given time is a function of, among other things, the amount of data processed concurrently by the server, including the number of connections supported and the number of data requests serviced. As recognized by the inventor hereof, what is needed is a means for dynamically managing the number of connections supported concurrently by a particular server, and/or the number of data requests processed concurrently, in such a manner as to improve the operating performance of the server.

Additionally, most cluster-based servers that act as relaying front-ends (where a dispatcher accepts each client request as its own and then forwards it to one of the servers in the pool) create and destroy connections between the dispatcher and back-end servers as connections between the dispatcher and clients are established and destroyed. That is, the state of the art is to maintain a one-to-one mapping of back-end connections to front-end connections. As recognized by the inventor hereof, however, this can create needless server overhead, especially for short TCP connections including those common to HTTP/1.0.

### SUMMARY OF THE INVENTION

In order to solve these and other needs in the art, the inventor has succeeded at designing standalone and cluster-based servers, including Web servers, which control the amount of data processed concurrently by such servers to thereby control server operating performance. As recognized by the inventor, it is often possible to increase one or more performance metrics for a server (e.g., server throughput) by decreasing the number of concurrently processed data requests and/or the number of concurrently supported connections. A dispatcher is preferably interposed between clients and one or more back-end servers, and preferably monitors the performance of each back-end server (either directly or otherwise). For each back-end server, the dispatcher preferably also controls, in response to the monitored performance, either or both of the number of concurrently processed data requests and the number of concurrently supported connections to thereby control the back-end servers' performance. In one embodiment, the dispatcher uses a packet capture library for capturing packets at OSI layer 2 and implements a simplified TCP/IP protocol in user-space (vs. kernel space) to reduce data copying. Commercially off-the-shelf (COTS) hardware and operating system software are preferably employed to take advantage of their price-to-performance ratio.

In accordance with one aspect of the present invention, a server for providing data to clients includes a dispatcher having a queue for storing requests received from clients, and at least one back-end server. The dispatcher stores in the queue one or more of the requests received from clients when the back-end server is unavailable to process the one or more requests. The dispatcher retrieves the one or more requests from the queue for forwarding to the back-end server when the back-end server becomes available to process them. The dispatcher determines whether the back-end server is available to process the one or more requests by comparing a number of connections concurrently supported by the back-end server to a maximum number of concurrent connections that the back-end server is permitted to support, where the maximum number is less than a maximum number of connections which the back-end server is capable of supporting concurrently.

In accordance with another aspect of the present invention, a method for controlled server loading includes the steps of defining a maximum number of concurrent connections that a server is permitted to support, limiting a number of concurrent connections supported by the server to the maximum number, monitoring the server's performance while it supports the concurrent connections, and dynamically adjusting the maximum number as a function of the server's performance to thereby control a performance factor for the server.

In accordance with a further aspect of the present invention, a method for controlled server loading includes the steps of receiving a plurality of data requests from clients, forwarding a number of the data requests to a server for processing, and storing at least one of the data requests until the server completes processing at least one of the forwarded data requests.

In accordance with still another aspect of the present invention, a method for controlled server loading includes the steps of defining a maximum number of data requests that a server is permitted to process concurrently, monitoring the server's performance, and dynamically adjusting the maximum number in response to the monitoring step to thereby adjust the server's performance.

In accordance with a further aspect of the invention, a method for controlled loading of a cluster-based server having a dispatcher and a plurality of back-end servers includes the steps of receiving at the dispatcher a plurality of data requests from clients, forwarding a plurality of the data requests to each of the back-end servers for processing, and storing at the dispatcher at least one of the data requests until one of the back-end servers completes processing one of the forwarded data requests.

In accordance with yet another aspect of the invention, a method for controlled loading of a cluster-based server having a dispatcher and a plurality of back-end servers includes the steps of defining, for each back-end server, a maximum number of data requests that can be processed concurrently, monitoring the performance of each back-end server, and dynamically adjusting the maximum number for at least one of the back-end servers in response to the monitoring step to thereby adjust the performance of the cluster-based server.

In accordance with still another aspect of the present invention, a computer-readable medium has computer-executable instructions stored thereon for implementing any one or more of the servers and methods described herein.

Other aspects and features of the present invention will be in part apparent and in part pointed out hereinafter.

### BRIEF DESCRIPTION OF THE DRAWINGS

FIG. 1 is a block diagram of a server having an L7/3 dispatcher according to one embodiment of the present invention.

FIG. 2 is a block diagram of a cluster-based server having an L7/3 dispatcher according to another embodiment of the present invention.

FIG. 3 is a block diagram of a server having an L4/3 dispatcher according to a further embodiment of the present invention.

FIG. 4 is a block diagram of a cluster-based server having an L4/3 dispatcher according to yet another embodiment of the present invention.

FIG. 5 is a block diagram of a simplified TCP/IP protocol implemented by the L7/3 dispatcher of FIG. 2.

FIG. 6 is an activity diagram illustrating the processing of packets using the simplified TCP/IP protocol of FIG. 5.

FIG. 7(a) is a state diagram for the L7/3 dispatcher of FIG. 2 as it manages front-end connections.

FIG. 7(b) is a state diagram for the L7/3 dispatcher of FIG. 2 as it manages back-end connections.

FIG. 8 illustrates a two-dimensional server mapping array for storing connection information.

FIG. 9 is a block diagram illustrating the manner in which back-end connections are maintained.

FIG. 10 illustrates the manner in which the dispatcher of FIG. 2 translates sequence information for a packet passed from a back-end connection to a front-end connection.

Corresponding reference characters indicate corresponding features throughout the several views of the drawings.

### DETAILED DESCRIPTION OF PREFERRED EMBODIMENTS

A Web server according to one preferred embodiment of the present invention is illustrated in FIG. 1 and indicated generally by reference character 100. As shown in FIG. 1, the server 100 includes a dispatcher 102 and a back-end server 104 (the phrase “back-end server” does not require server 100 to be a cluster-based server). In this particular embodiment, the dispatcher 102 is configured to support open systems integration (OSI) layer seven (L7) switching (also known as content-based routing), and includes a queue 106 for storing data requests (e.g., HTTP requests) received from exemplary clients 108, 110, as further explained below. Preferably, the dispatcher 102 is transparent to both the clients 108, 110 and the back-end server 104. That is, the clients perceive the dispatcher as a server, and the back-end server perceives the dispatcher as one or more clients.

The dispatcher 102 preferably maintains a front-end connection 112, 114 with each client 108, 110, and a dynamic set of persistent back-end connections 116, 118, 120 with the back-end server 104. The back-end connections 116-120 are persistent in the sense that the dispatcher 102 can forward multiple data requests to the back-end server 104 over the same connection. Also, the dispatcher can preferably forward data requests received from different clients to the back-end server 104 over the same connection, when desirable. This is in contrast to using client-specific back-end connections, as is done for example in prior art L7/3 cluster-based servers. As a result, back-end connection overhead is markedly reduced. Alternatively, non-persistent and/or client-specific back-end connections may be employed. The set of back-end connections 116-120 is dynamic in the sense that the number of connections maintained between the dispatcher 102 and the back-end server 104 may change over time, including while the server 100 is in use.

The front-end connections 112, 114 may be established using HTTP/1.0, HTTP/1.1 or any other suitable protocol, and may or may not be persistent.

Each back-end connection 116-120 preferably remains open until terminated by the back-end server 104 when no data request is received over that connection within a certain amount of time (e.g., as defined by HTTP/1.1), or until terminated by the dispatcher 102 as necessary to adjust the performance of the back-end server 104, as further explained below.

The back-end connections 116-120 are initially established using the HTTP/1.1 protocol (or any other protocol supporting persistent connections) either before or after the front-end connections 112-114 are established. For example, the dispatcher may initially define and establish a default number of persistent connections to the back-end server before, and in anticipation of, establishing the front-end connections. This default number is typically less than the maximum number of connections that can be supported concurrently by the back-end server 104 (e.g., if the back-end server can support up to 256 concurrent connections, the default number may be five, ten, one hundred, etc., depending on the application). Preferably, this default number represents the number of connections that the back-end server 104 can readily support while yielding good performance. It should therefore be apparent that the default number of permissible connections selected for any given back-end server will depend upon that server's hardware and/or software configuration, and may also depend upon the particular performance metric (e.g., request rate, average response time, maximum response time, throughput, etc.) to be controlled, as discussed further below. Alternatively, the dispatcher 102 may establish the back-end connections on an as-needed basis (i.e., as data requests are received from clients) until the default (or subsequently adjusted) number of permissible connections for the back-end server 104 is established. When a back-end connection is terminated by the back-end server, the dispatcher may establish another back-end connection immediately, or when needed.

According to the present invention, the performance of a server may be enhanced by limiting the amount of data processed by that server at any given time. For example, by limiting the number of data requests processed concurrently by a server, it is possible to reduce the average response time and increase server throughput. Thus, in the embodiment under discussion, the dispatcher 102 is configured to establish connections with clients and accept data requests therefrom to the fullest extent possible while, at the same time, limit the number of data requests processed by the back-end server 104 concurrently. In the event that the dispatcher 102 receives a greater number of data requests than what the back-end server 104 can process efficiently (as determined with reference to a performance metric for the back-end server), the excess data requests are preferably stored in the queue 106.

Once a data request is forwarded by the dispatcher 102 over a particular back-end connection, the dispatcher will preferably not forward another data request over that same connection until it receives a response to the previously forwarded data request. In this manner, the maximum number of data requests processed by the back-end server 104 at any given time can be controlled by dynamically controlling the number of back-end connections 116-120. Limiting the number of concurrently processed data requests prevents thrashing of server resources by the back-end server's operating system, which could otherwise degrade performance.

A back-end connection over which a data request has been forwarded, and for which a response is pending, may be referred to as an “active connection.” A back-end connection over which no data request has as yet been forwarded, or over which no response is pending, may be referred to as an “idle connection.”

Data requests arriving from clients at the dispatcher 102 are forwarded to the back-end server 104 for processing as soon as possible and, in this embodiment, in the same order that such data requests arrived at the dispatcher. Upon receiving a data request from a client, the dispatcher 102 selects an idle connection for forwarding that data request to the back-end server 104. When no idle connection is available, data requests received from clients are stored in the queue 106. Thereafter, each time an idle connection is detected, a data request is retrieved from the queue 106, preferably on a FIFO basis, and forwarded over the formerly idle (now active) connection. Alternatively, the system may be configured such that all data requests are first queued, and then dequeued as soon as possible (which may be immediately) for forwarding to the back-end server 104 over an idle connection. After receiving a response to a data request from the back-end server 104, the dispatcher 102 forwards the response to the corresponding client.

Client connections are preferably processed by the dispatcher 102 on a first come, first served (FCFS) basis. When the number of data requests stored in the queue 106 exceeds a defined threshold, the dispatcher preferably denies additional connection requests (e.g., TCP requests) received from clients (e.g., by sending an RST to each such client). In this manner, the dispatcher 102 ensures that already established front-end connections 108-110 are serviced before requests for new front-end connections are accepted. When the number of data requests stored in the queue 106 is below a defined threshold, the dispatcher may establish additional front-end connections upon request until the maximum number of front-end connections that can be supported by the dispatcher 102 is reached, or until the number of data requests stored in the queue 106 exceeds the defined threshold.

As noted above, the dispatcher 102 maintains a variable number of persistent connections 116-120 with the back-end server 104. In essence, the dispatcher 102 implements a feedback control system by monitoring a performance metric for the back-end server 104 and then adjusting the number of back-end connections 116-120 as necessary to adjust the performance metric as desired. For example, suppose a primary performance metric of concern for the back-end server 104 is overall throughput. If the monitored throughput falls below a minimum level, the dispatcher 102 may adjust the number of back-end connections 116-120 until the throughput returns to an acceptable level. Whether the number of back-end connections should be increased or decreased to increase server throughput will depend upon the specific configuration and operating conditions of the back-end server 104 in a given application. This decision may also be based on past performance data for the back-end server 104. The dispatcher 102 may also be configured to adjust the number of back-end connections 116-120 so as to control a performance metric for the back-end server 104 other than throughput, such as, for example, average response time, maximum response time, etc. For purposes of stability, the dispatcher 102 is preferably configured to maintain the performance metric of interest within an acceptable range of values, rather than at a single specific value.

In the embodiment under discussion, where all communications with clients 108-110 pass through the dispatcher 102, the dispatcher can independently monitor the performance metric of concern for the back-end server 104. Alternatively, the back-end server may be configured to monitor its performance and provide performance information to the dispatcher.

As should be apparent from the description above, the dispatcher 102 may immediately increase the number of back-end connections 116-120 as desired (until the maximum number of connections which the back-end server is capable of supporting is reached). To decrease the number of back-end connections, the dispatcher 102 preferably waits until a connection becomes idle before terminating that connection (in contrast to terminating an active connection over which a response to a data request is pending).

The dispatcher 102 and the back-end server 104 may be implemented as separate components, as illustrated generally in FIG. 1. Alternatively, they may be integrated in a single computer device having at least one processor. For example, the dispatcher functionality may be integrated into a conventional Web server (having sufficient resources) for the purpose of enhancing server performance. In one particular implementation of this embodiment, the server 100 achieved nearly three times the performance, measured in terms of HTTP request rate, of a conventional Web server.

A cluster-based server 200 according to another preferred embodiment of the present invention is shown in FIG. 2, and is preferably implemented in manner similar to the embodiment described above with reference to FIG. 1, except as noted below. As shown in FIG. 2, the cluster-based server 200 employs multiple back-end servers 202, 204 for processing data requests provided by exemplary clients 206, 208 through an L7 dispatcher 210 having a queue 212. The dispatcher 210 preferably manages a dynamic set of persistent back end connections 214-218, 220-224 with each back-end server 202, 204, respectively. The dispatcher 210 also controls the number of data requests processed concurrently by each back-end server at any given time in such a manner as to improve the performance of each back-end server and, thus, the cluster-based server 200.

As in the embodiment of FIG. 1, the dispatcher 210 preferably refrains from forwarding a data request to one of the back-end servers 202-204 over a particular connection until the dispatcher 210 receives a response to a prior data request forwarded over the same particular connection (if applicable). As a result, the dispatcher 210 can control the maximum number of data requests processed by any back-end server at any given time simply by dynamically controlling the number of back-end connections 214-224.

While only two back-end servers 202, 204 and two exemplary clients 206, 208 are shown in FIG. 2, those skilled in the art will recognize that additional back-end servers may be employed, and additional clients supported, without departing from the scope of the invention. Likewise, although FIG. 2 illustrates the dispatcher 210 as having three persistent connections 214-218, 220-224 with each back-end server 202, 204, it should be apparent from the description below that the set of persistent connections between the dispatcher and each back-end server may include more or less than three connections at any given time, and the number of persistent connections in any given set may differ at any time from that of another set.

The default number of permissible connections initially selected for any given back-end server will depend upon that server's hardware and/or software configuration, and may also depend upon the particular performance metric (e.g., request rate, throughput, average response time, maximum response time, etc.) to be controlled for that back-end server. Preferably, the same performance metric is controlled for each back-end server.

An “idle server” refers to a back-end server having one or more idle connections, or to which an additional connection can be established by the dispatcher without exceeding the default (or subsequently adjusted) number of permissible connections for that back-end server.

Upon receiving a data request from a client, the dispatcher preferably selects an idle server, if available, and then forwards the data request to the selected server. If no idle server is available, the data request is stored in the queue 212. Thereafter, each time an idle connection is detected, a data request is retrieved from the queue 212, preferably on a FIFO basis, and forwarded over the formerly idle (now active) connection. Alternatively, the system may be configured such that all data requests are first queued and then dequeued as soon as possible (which may be immediately) for forwarding to an idle server.

To the extent that multiple idle servers exist at any given time, the dispatcher preferably forwards data requests to these idle servers on a round-robin basis. Alternatively, the dispatcher can forward data requests to the idle servers according to another load sharing algorithm, or according to the content of such data requests (i.e., content-based dispatching). Upon receiving a response from a back-end server to which a data request was dispatched, the dispatcher forwards the response to the corresponding client.

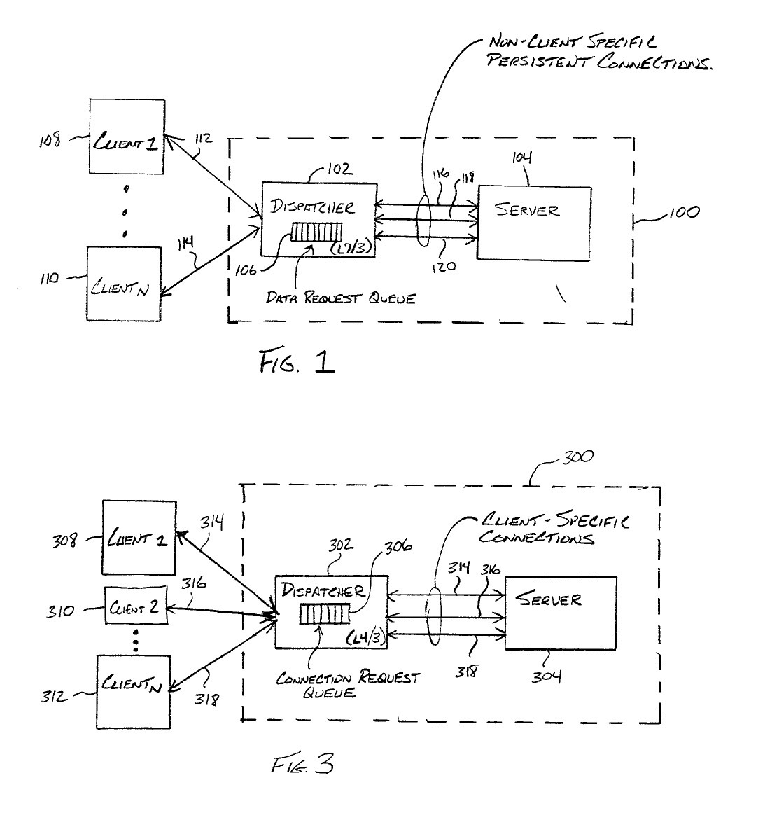

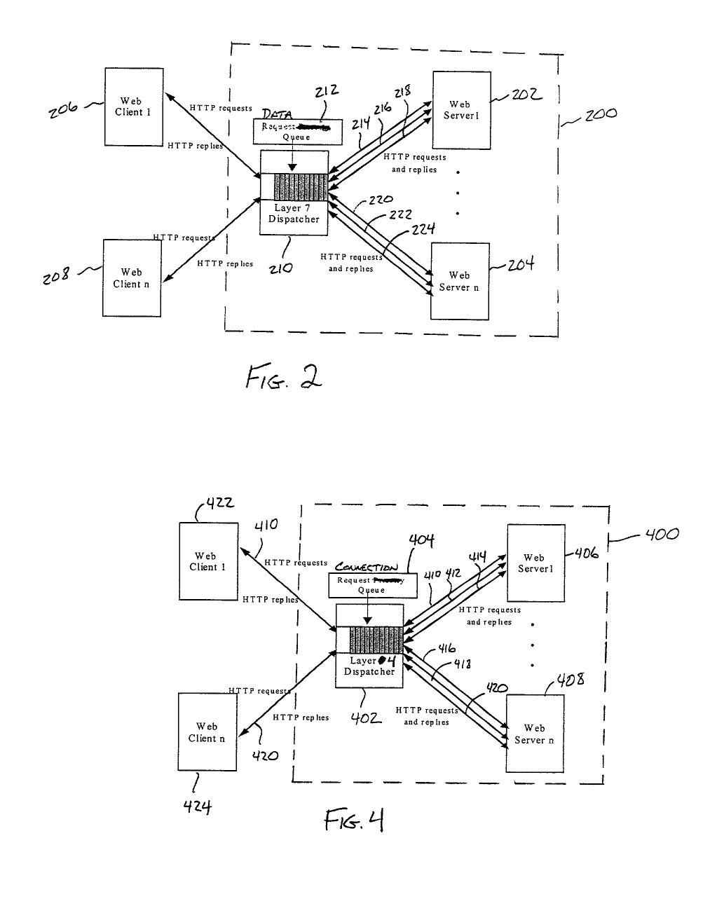

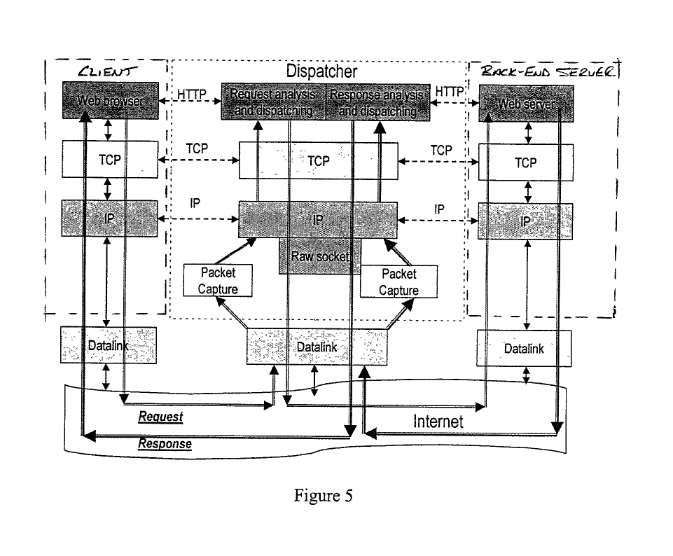

A Web server according to another preferred embodiment of the present invention is illustrated in FIG. 3 and indicated generally by reference character 300. Similar to the server 100 of FIG. 1, the server 300 of FIG. 3 includes a dispatcher 302 and a back-end server 304. However, in this particular embodiment, the dispatcher 302 is configured to support open systems integration (OSI) layer four (L4) switching. Thus, connections 314-318 are made between exemplary clients 308-312 and the back-end server 304 directly rather than with the dispatcher 302. The dispatcher 302 includes a queue 306 for storing connection requests (e.g., SYN packets) received from clients 308-312.

Similar to other preferred embodiments described above, the dispatcher 302 monitors a performance metric for the back-end server 304 and controls the number of connections 314-318 established between the back-end server 304 and clients 308-312 to thereby control the back-end server's performance. Preferably, the dispatcher 302 is an L4/3 dispatcher (i.e., it implements layer 4 switching with layer 3 packet forwarding), thereby requiring all transmissions between the back-end server 304 and clients 308-312 to pass through the dispatcher. As a result, the dispatcher 302 can monitor the back-end server's performance directly. Alternatively, the dispatcher can monitor the back-end server's performance via performance data provided to the dispatcher by the back-end server, or otherwise.

The dispatcher 302 monitors a performance metric for the back-end server 304 (e.g., average response time, maximum response time, server packet throughput, etc.) and then dynamically adjusts the number of connections 314-318 to the back-end server 304 as necessary to adjust the performance metric as desired. The number of connections is dynamically adjusted by controlling the number of connection requests (e.g., SYN packets), received by the dispatcher 302 from clients 308-312, that are forwarded to the back-end server 304.

Once a default number of connections 314-318 are established between the back-end server 304 and clients 308-312, additional connection requests received at the dispatcher 302 are preferably stored in the queue 306 until one of the existing connections 314-318 is terminated. At that time, a stored connection request can be retrieved from the queue 306, preferably on a FIFO basis, and forwarded to the back-end server 304 (assuming the dispatcher has not reduced the number of permissible connections to the back-end server). The back-end server 304 will then establish a connection with the corresponding client and process data requests received over that connection.

FIG. 4 illustrates a cluster-based embodiment of the Web server 300 shown in FIG. 3. As shown in FIG. 4, a cluster-based server 400 includes an L4/3 dispatcher 402 having a queue 404 for storing connection requests, and several back-end servers 406, 408. As in the embodiment of FIG. 3, connections 410-420 are made between exemplary clients 422, 424 and the back-end servers 406, 408 directly. The dispatcher 402 preferably monitors the performance of each back-end server 406, 408 and dynamically adjusts the number of connections therewith, by controlling the number of connection requests forwarded to each back-end server, to thereby control their performance.

A detailed implementation of the L7/3 cluster-based server 200 shown in FIG. 2 will now be described with reference to FIGS. 5-10. All functions of the dispatcher 210 are preferably implemented via a software application implementing a simplified TCP/IP protocol, shown in FIG. 5, and running in user-space (in contrast to kernel space) on commercially off-the-shelf (“COTS”) hardware and operating system software. In one preferred embodiment, this software application runs under the Linux operating system or another modern UNIX system supporting libpcap, a publicly available packet capture library, and POSIX threads. As a result, the dispatcher can capture the necessary packets in the datalink layer.

When a packet arrives at the datalink layer of the dispatcher 210, the packet is preferably applied to each filter defined by the dispatcher, as shown in FIG. 5. The packet capture device then captures all the packets in which it is interested. For example, the packet capture device can operate in a promiscuous mode, during which all packets arriving at the datalink layer are copied to a packet capture buffer and then filtered, through software, according to, e.g., their source IP or MAC address, protocol type, etc. Matching packets can then be forwarded to the application making the packet capture call, whereas non-matching packets can be discarded. Alternatively, packets arriving at the datalink layer can be filtered through hardware (e.g., via a network interface card) in addition to or instead of software filtering. In the latter case, interrupts are preferably generated at the hardware level only when broadcast packets or packets addressed to that hardware are received.

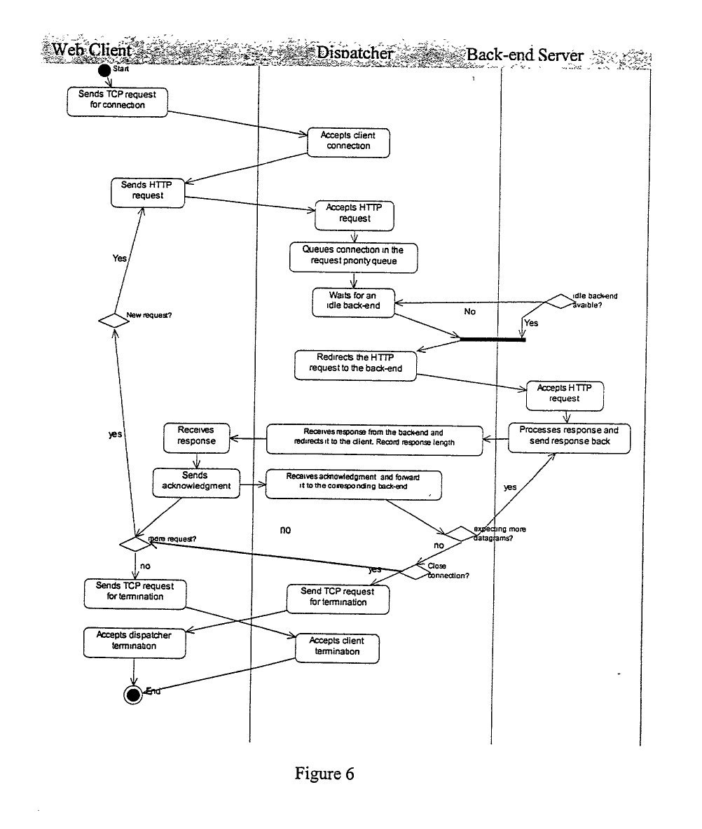

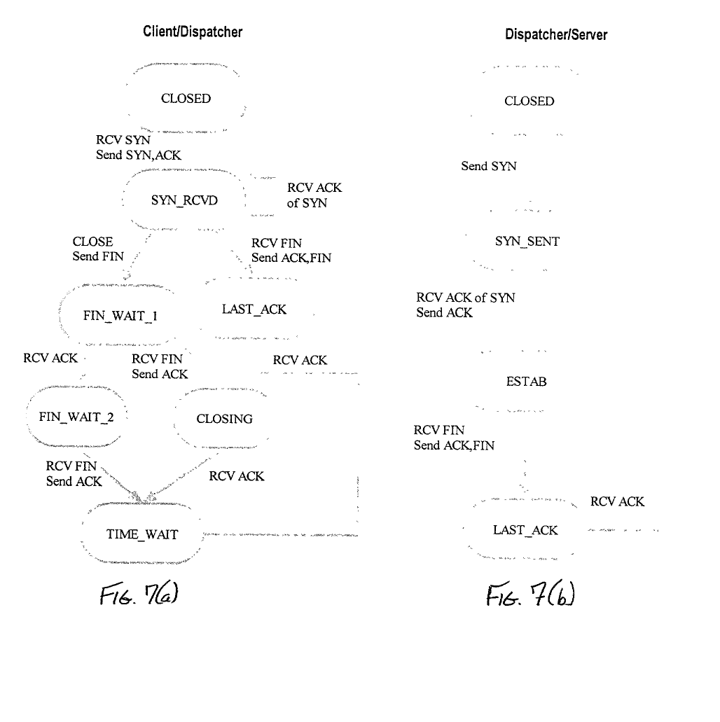

In this embodiment, two packet capture devices are used to capture packets from the clients 206-208 and the back-end servers 202-204, respectively. These packets are then decomposed and analyzed using the simplified TCP/IP protocol, as further described below. Packets seeking to establish or terminate a connection are preferably handled by the dispatcher 210 immediately. Packets containing data requests (e.g., HTTP requests) are stored in the queue 212 when all of the back-end connections 214-224 are active. When an idle server is detected, a data request is dequeued, combined with corresponding TCP and IP headers, and sent to this server using a raw socket (raw socket is provided in many operating systems, e.g., UNIX, for users to read and write raw network protocol datagrams with a protocol field that is not processed by the kernel). Packets containing response data from a back-end server are combined with appropriate TCP and IP headers and passed to the corresponding client using raw sockets. This process is illustrated by the activity diagram of FIG. 6.

The simplified TCP/IP protocol implemented in the dispatcher application software will now be described. The primary use of the IP protocol is to obtain the source and destination addresses of packets. Because, in this particular embodiment, the dispatcher and the back-end servers are interconnected through a local area network (LAN), the maximum transmission unit (MTU) of the TCP segment is small and does not require fragmentation when it arrives at the IP layer. Therefore, IP refragmentation is omitted. Additionally, due to the properties of the front-end connections and the back-end connections, the following TCP specifications are simplified or omitted:

a. Sequence Number Space. Sequence space is used for sequencing the data transmitted. In UNIX, about thirteen variables are used to implement the sequence window scaling and sliding. All packets transmitted to establish and terminate a connection are short and in sequence except for retransmitted packets. Once a request has been assigned to a server, which is when bulk data transmission occurs, the dispatcher acts like a gateway, whose function is too simply change packet header fields and pass packets. Thus, the sequence window in this embodiment is simplified to have a size of one, to deal with connection setup and termination.

b. Timers.

1. Retransmission. Retransmission is done in TCP to avoid data loss when the sender does not receive an acknowledgement within a certain period. Since the back-end servers are distributed in the same LAN, data loss is rare. When establishing a connection with a client, since the client is active, the client will retransmit the same packet if it does not receive the packet from the dispatcher. When terminating a connection with the client, if the dispatcher does not receive any response from the client for a certain period, the dispatcher will disconnect the connection. Therefore, retransmission can be omitted.

2. Persist timer. This is set when the other end of a connection advertises a window of zero, thereby stopping TCP from sending data. When it expires, one byte of data is sent to determine if the window has opened. This is not applicable since the bulk data transmission will not occur when establishing and terminating connections.

3. Delayed acknowledgement. This is used to improve the efficiency of the transmission. It is not applicable to establishing and terminating connections because an immediate response can be given, but could be used to acknowledge an HTTP request. Because maintaining an alarm or maintaining a time record and polling for each connection is expensive, this problem is solved by sending an acknowledgement to each HTTP request immediately after it is received.

c. Option Field. Three options are implemented in UNIX TCP: MSS (Maximum Segment Size), window scale, and timestamp. For simplicity, only the MSS option is implemented in this embodiment.

d. State Diagram. General TCP implementations consider all possible applications a host may have. For a Web server, some transitions may not happen at all. In this Web embodiment, the following scenarios are assumed not to happen: simultaneous open for front-end connections and for back-end connections; and simultaneous close for back-end connections. CLOSE_WAIT is also not implemented, as an immediate response can be sent to acknowledge the FIN flag without waiting for the application to finish its work before sending the FIN flag. State diagrams for the dispatcher 210 as it manages front-end and back-end connections are shown in FIGS. 7(a) and 7(b), respectively.

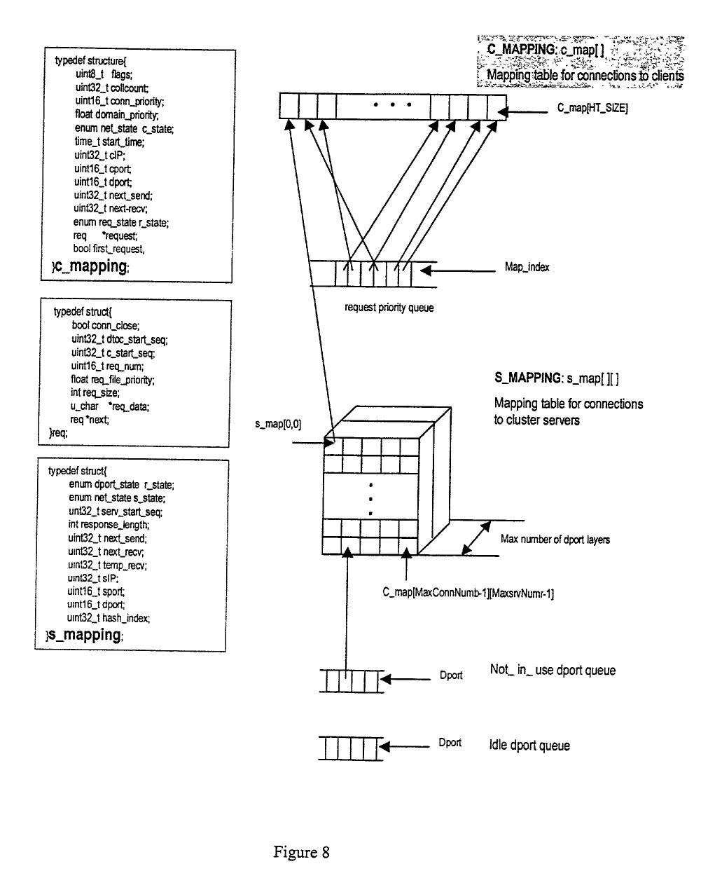

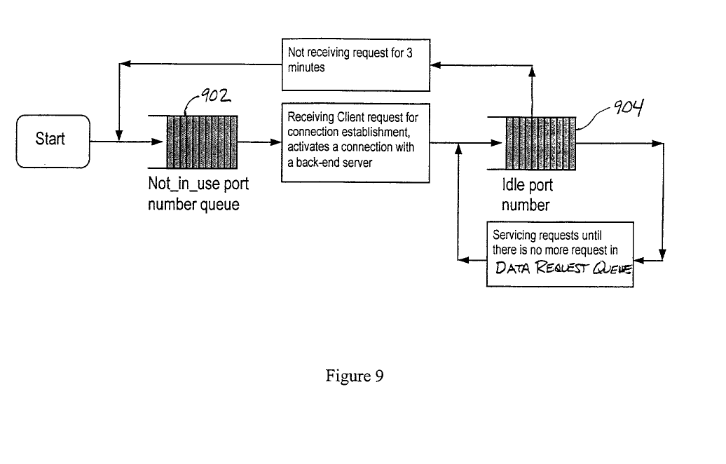

The preferred manner in which the dynamic sets of persistent back-end connections are managed will now be described with reference to FIGS. 8 and 9. As shown in FIG. 8, a two-dimensional server-mapping array is used to store the connection information between the dispatcher and the back-end servers. Alternatively, a linked list could be used. Each server is preferably associated with a unique index number, and newly added servers are assigned larger index numbers. Each connection to a back-end server is identified by a port number, which is used by the dispatcher to set up that connection.

A third dimension, port number layer, is preferably used to keep the number of connections fixed. For example, when a client connects to an Apache server using HTTP/1.1, the server will close the connection when it receives a bad request, which may be a non-existent URL. In this situation, the connection becomes unusable for a certain period of time (which varies by operating system). This means the port number is disabled. In order to maintain the active connection number, a new connection to the same server is preferably opened. Thus, a new memory space must be allocated for the connection. To efficiently use memory space and manage the connection set, the port number manager uses layers to assign a different port number and stores its information in the same slot. As shown in FIG. 8, a port number is uniquely determined by the index of the server, the connection index of this server, the index of port number layers, and the port start number. According to this approach, if the port start number is defined as 10000, then the port number used by the dispatcher to setup the first connection to the first back-end server will be 10000 and the second connection to the first back-end server will be 10001. If the number of permissible connections to a particular back-end server is, for example, eight, then the port number used by the dispatcher to setup the first connection to the second back-end server is 10008. If the maximum port layer number is five and the maximum server number is 256, then the maximum port number used to connect to a back-end server will be 10000+5*8*256−1=10239. The port number used by the dispatcher to setup any given connection can be determined from the following equation: dispatcher port number (dport)=iLayer*nserver*nServerConn+iServer*nServerConn+iServerConn, where i ranges from 0 to n−1, and n represents the number of layers, servers, and maximum number of connections per server, respectively. In other words, there are three different “n” values: one for the maximum number of layers; one for the maximum number of servers; and one for the maximum number of connections allowed per server.

To maintain the dynamic sets of connections with the back-end servers efficiently, two queues are preferably used: a not-in-use queue 902; and an idle queue 904. In this particular implementation in which back-end connections are established on an as-needed basis (rather than, e.g., initially establishing a default number of connections), all port numbers are initially inserted into the not-in-use queue 902 in such a way that each back-end server has an equal chance to be connected to by the dispatcher. When the dispatcher receives a connection request from a client, it removes a port number from the head of the not-in-use queue 902 and uses it to set up a connection with the corresponding back-end server. This port number is placed in the idle queue 904 once the connection is established. When a data request arrives from a client, the dispatcher matches the data request with an idle port, dequeues the associated port number from the idle queue 904, and forwards the data request to the back-end server associated with the dequeued port number. When the load of the dispatcher decreases and one or more back-end connections do not receive a data request within a certain time interval (which is three minutes in this particular implementation), this back-end connection(s) is terminated by the corresponding back-end server(s), and the corresponding port numbers are placed back into the not-in-use queue 902. Thus, the idle queue stores port numbers associated with idle connections, and the not-in-use queue stores port numbers not associated with an existing connection. In this manner, the network resources and the resources of the back-end servers are used efficiently.

The preferred manner in which connections are made between the dispatcher and clients will now be described. Information associated with these connections is preferably maintained using a hash table. Each hash entry is uniquely identified by a tuple of client IP address, client port number, and a dispatcher port number. To calculate the hash value, the client IP address and the client port number are used to get a hash index. Collision is handled using open addressing, which resolves the collision problems by polling adjacent slots until an empty one is found. To obtain the hash entry, the client IP address and port number are compared to those of entries in the hash slot. The dispatcher port numbers preferably have a one-to-one relationship with back-end servers. The hash index or map index that stores the information for a particular connection is preferably stored in the data request queue 212 shown in FIG. 2. Each time a hash index is dequeued, the corresponding connection is found, and the head of its request list is dispatched to a back-end server. This index is stored in the server-mapping table for mapping the response to the connection. After the response from a back-end server is acknowledged, the data request is discarded and the connection is either terminated (for HTTP/1.0 sessions) or placed in the data request queue 212.

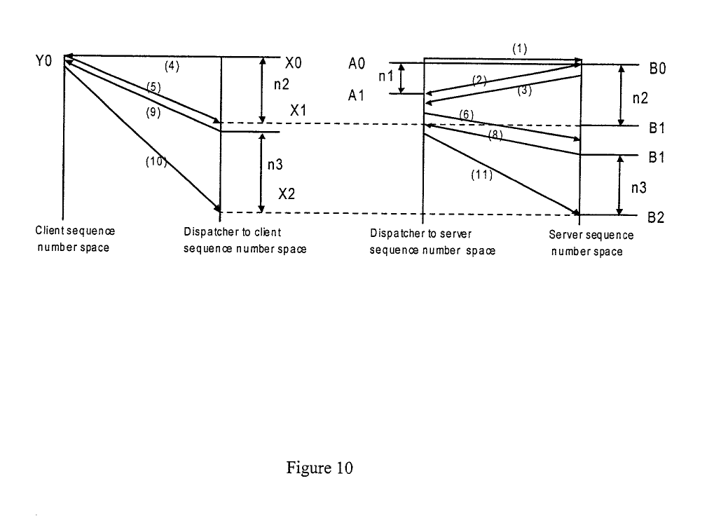

According to the TCP protocol specification, a sequence number space is maintained by each side of a connection to control the transmission. When a packet arrives from a back-end server, it includes sequence information specific to the connection between the back-end server and the dispatcher. This packet must then be changed by the dispatcher to carry sequence information specific to the front-end connection between the dispatcher and the associated client. FIG. 10 provides an example of how the packet sequence number is changed while it is passed by the dispatcher. The four sequence numbers are represented using the following symbols:

X—the sequence number of the next byte to be sent to the client by the dispatcher.

Y—the sequence number of the next byte to be sent to the dispatcher by the client.

A—the sequence number of the next byte to be sent to the server by the dispatcher.

B—the sequence number of the next byte to be sent to the dispatcher by the server.

In step (1), after the dispatcher sends a client's request to a selected back-end server, it saves the initial sequence numbers X0 and B0. In step (2), the dispatcher receives the acknowledgement from the selected server so it increases A0 to A1 (A1=A0+n1, where n1 is the request size, or number of bytes, sent to the back-end server). In step (3), the dispatcher receives the first response packet from the back-end server with the sequence number B0 and the acknowledgement number A1. Since this is the first response, the dispatcher searches the header of the packet for content-length field and records the total bytes that the server is sending to the client. In step (4), the dispatcher changes the sequence number to X0 and the acknowledgement number to Y0 and forwards the packet to the client. The address space and checksum of the packet are also updated accordingly every time the packet is passed. In step (5), the dispatcher receives the acknowledgement from the client with the sequence number Y0 and the acknowledgement number Z. The dispatcher compares Z with X0; if z>X0, then the dispatcher updates X0 to X1; otherwise, it keeps X0. In step (6), the dispatcher changes the sequence number to A1 and the acknowledgment number to B1 and sends it to the back-end server. B1 is determined by B0 and the difference between X1 and X0, which represents the number of bytes that the client has received. Thus, B1=B0+X1−X0. Based on this acknowledgement, the dispatcher calculates the remaining packet length to be received. Since the remaining packet length is greater than zero, the dispatcher waits for the next packet. In step (7), the dispatcher receives the second response packet from the server with the sequence number B1 (assuming the length of the first packet is n2, then B1=B0+n2) and the acknowledgment number Al. In step (8), the dispatcher changes the sequence number to X1 and the acknowledgement number to Y0 and sends the packet to the client. In step (9), the dispatcher receives the acknowledgment from the client and repeats the same work done in step (5). In step (10), the dispatcher repeats the functions performed in step (6).

From the foregoing description, it should be understood that the dispatcher preferably does not acknowledge the amount of data it receives from the server. Instead, it passes the packet on to the client and acknowledges it only after it receives the acknowledgement from the client. In this way, the server is responsible for the retransmission when it has not received an acknowledgment within a certain period, and the client is responsible for the flow control if it runs out of buffer space.

According to the TCP protocol specification, the TIME_WAIT state is provided for a sender to wait for a period of time to allow the acknowledgement packet sent by the sender to die out in the network. A soft timer and a queue are preferably used to keep track of this time interval. When a connection enters the TIME_WAIT state, its hash index is placed in the TIME_WAIT queue. The queue is preferably checked every second if the interval exceeds a certain period. For UNIX, this interval is one minute, but in the particular implementation of the invention under discussion, because of the short transmission time and short route, it is preferably set to one second. The soft timer, which is realized by reading the system time each time after the program has finished processing one packet, is preferably used instead of a kernel alarm to eliminate the overhead involved in the interrupt caused by the kernel.

While the present invention has been described primarily in a Web server context, those skilled in the art will recognize that the teachings of the invention are applicable to other server applications as well.

When introducing elements of the present invention or the preferred embodiment(s) thereof, the articles “a”, “an”, “the” and “said” are intended to mean that there are one or more such elements. The terms “comprising”, “including” and “having” are intended to be inclusive and mean that there may be additional elements other than those listed.

As various changes could be made in the above constructions without departing from the scope of the invention, it is intended that all matter contained in the above description or shown in the accompanying drawings shall be interpreted as illustrative and not in a limiting sense.

What is claimed is:

1. A server for providing data to clients, the server comprising:
a dispatcher having a queue for storing requests received from clients; and
at least one back-end server;
wherein the dispatcher stores in the queue one or more of the requests received from clients when the back-end server is unavailable to process said one or more requests;
wherein the dispatcher retrieves said one or more requests from the queue for forwarding to the back-end server when the back-end server becomes available to process said one or more requests; and
wherein the dispatcher determines whether the back-end server is available to process said one or more requests by comparing a number of connections concurrently supported by the back-end server to a maximum number of concurrent connections that the back-end server is permitted to support, the maximum number being less than a maximum number of connections which the back-end server is capable of supporting concurrently.

2. The server of claim 2 wherein the dispatcher is configured to monitor a performance of the back-end server, to define the maximum number of concurrent connections that the back-end server is permitted to support, and to dynamically adjust the maximum number in response to the monitored performance.

3. The server of claim 1 wherein the server is a cluster-based server comprising a plurality of back-end servers, the dispatcher is configured to store in the queue said one or more requests when none of the back-end servers are available to process said one or more requests, and the dispatcher is further configured to retrieve said one or more requests from the queue for forwarding to one of the back-end servers when said one of the back-end servers becomes available to process said one or more requests.

4. The server of claim 1 wherein the server is a Web server.

5. The server of claim 1 wherein the dispatcher and the back-end server are implementing using COTS hardware.

6. The server of claim 1 wherein the dispatcher comprises a first computer device, the back-end server comprises a second computer device, and the first and second computer devices are configured to communicate with one another over a computer network.

7. The server of claim 1 wherein the dispatcher is an OSI layer 7 dispatcher and said requests are data requests.

8. The server of claim 7 wherein the dispatcher implements a simplified TCP/IP protocol in user-space.

9. The server of claim 1 wherein the dispatcher is an OSI layer 4 dispatcher and said requests are connection requests.

10. A computer-readable medium having computer-executable instructions for performing the method of claim 1.

11. A method for controlled server loading, the method comprising the steps of:
defining a maximum number of concurrent connections that a server is permitted to support;
limiting a number of concurrent connections supported by the server to the maximum number;
monitoring the server's performance while it supports the concurrent connections; and
dynamically adjusting the maximum number as a function of the server's performance to thereby control a performance factor for the server.

12. The method of claim 11 wherein the defining step includes defining the maximum number to be less than a maximum number of connections which the server is capable of supporting concurrently.

13. The method of claim 11 wherein the concurrent connections are connections between the server and clients.

14. The method of claim 11 wherein the concurrent connections are connections between the server and a dispatcher.

15. The method of claim 11 wherein the server is a back-end server in a cluster-based server having a dispatcher, and the dynamically adjusting step includes dynamically adjusting the maximum number of concurrent connections that can be established between the back-end server and the dispatcher.

16. The method of claim 15 wherein each concurrent connection is a persistent connection over which data requests from multiple clients can be sent by the dispatcher to the back-end server.

17. The method of claim 11 wherein the dynamically adjusting step includes dynamically adjusting the maximum number in response to the monitoring step such that the server operates at or above a minimum performance level.

18. The method of claim 17 wherein the monitoring step includes monitoring the server's performance level in terms of a performance metric selected from the group consisting of request rate, average response time, maximum response time and server throughput.

19. A method for controlled server loading, the method comprising the steps of:
receiving a plurality of data requests from clients;
forwarding a number of the data requests to a server for processing; and
storing at least one of the data requests until the server completes processing at least one of the forwarded data requests.

20. The method of claim 19 further comprising the steps of retrieving the stored data request after the server completes processing at least one of the forwarded data requests, and forwarding the retrieved data request to the server for processing.

21. The method of claim 19 wherein the storing step includes storing a plurality of the data requests, the method further comprising the step of retrieving one of the stored data requests and forwarding the retrieved one of the data requests to the server for processing each time the server completes processing one of the forwarded data requests.

22. The method of claim 21 wherein the retrieving step includes retrieving the stored data requests on a FIFO basis.

23. The method of claim 19 wherein the data requests are HTTP requests.

24. The method of claim 19 wherein the receiving, forwarding and storing steps are performed by a single computer device having at least one processor.

25. The method of claim 24 wherein the single computer device comprises the server.

26. The method of claim 19 wherein the storing step is performed by a dispatcher and includes storing at least one of the data requests until the dispatcher receives a response from the server to at least one of the forwarded data requests.

27. A method for controlled server loading, the method comprising the steps of:
defining a maximum number of data requests that a server is permitted to process concurrently;
monitoring the server's performance; and
dynamically adjusting the maximum number in response to the monitoring step to thereby adjust the server's performance.

28. The method of claim 27 wherein the monitoring step includes monitoring the server's performance in terms of a performance metric selected from the group consisting of request rate, average response time, maximum response time, and server throughput.

29. The method of claim 27 further comprising the steps of receiving a plurality of data requests from clients, forwarding some of the data requests to the server for processing, and storing at least one of the data requests until the server completes processing one of the forwarded data requests.

30. The method of claim 27 wherein the defining step includes defining a maximum number of connections that can be supported concurrently by the server and limiting the number of data requests that can be pending on each connection.

31. The method of claim 30 wherein the defining step includes limiting the number of data requests that can be pending on each connection to one.

32. A method for controlled loading of a cluster-based server, the cluster-based server including a dispatcher and a plurality of back-end servers, the method comprising the steps of:
receiving at the dispatcher a plurality of data requests from clients;
forwarding a plurality of the data requests to each of the back-end servers for processing; and
storing at the dispatcher at least one of the data requests until one of the back-end servers completes processing one of the forwarded data requests.

33. The method of claim 32 wherein the storing step includes storing a plurality of the data requests and the forwarding step includes forwarding one of the stored data requests to one of the back-end servers each time one of the back-end servers completes processing one of the forwarded data requests.

34. The method of claim 32 wherein the cluster-based server is an L7/3 server.

35. A method for controlled loading of a cluster-based server, the cluster-based server including a dispatcher and a plurality of back-end servers, the method comprising the steps of:
defining, for each back-end server, a maximum number of data requests that can be processed concurrently;
monitoring the performance of each back-end server; and
dynamically adjusting the maximum number for at least one of the back-end servers in response to the monitoring step to thereby adjust the performance of the cluster-based server.

36. The method of claim 35 wherein the dynamically adjusting step includes dynamically adjusting the maximum number for each back-end server.

37. The method of claim 35 wherein the dynamically adjusting step includes dynamically adjusting the maximum number for said one of the back-end servers as a function of that back-end server's performance.

38. The method of claim 35 further comprising the steps of receiving a plurality of data requests from clients, forwarding some of the data requests to the back-end servers for processing, and storing at least one of the data requests until one of the back-end servers completes processing one of the forwarded data requests.
